(19) United States
(12) Patent Application Publication
(10) Pub. No.: US 2004/0252513 A1
(43) Pub. Date: Dec. 16, 2004

(54) Packaging for a lamp and method for packaging a lamp

(75) Inventors: Gerhard Hagel, Furth (DE); Manfred Reinhardt, Feuchtwangen (DE); Dieter Helmut Schonlein, Horn-Bad Meinberg (DE)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Patent-Treuhand-Gesellschaft fur Elektrische Gluhlampen mbH, Munich (DE)

(21) Appl. No.: 10/839,894

(22) Filed: May 5, 2004

(30) Foreign Application Priority Data
Jun. 6, 2003 (DE) 10326131.1

(51) Int. Cl. B60Q 3/04

(52) U.S. Cl. 362/362

(57) ABSTRACT

The invention relates to packaging for a lamp (2) having an inner part (1), which has a recess (11) for the lamp (2) which is matched in an interlocking manner to the outer contour of the lamp (2) such that the interlocking design of the recess (11) causes the lamp (2) to be anchored in the recess (11).

The invention relates to packaging for a lamp according to the preamble of patent claim 1 and to a method for packaging an electrical lamp according to the preamble of patent claim 8.

### I. PRIOR ART

Such packaging is disclosed, for example, in the international industrial design DM/046 932. This packaging comprises two plastic half-shells which are each provided with a depression for the lamp.

### II. SUMMARY OF THE INVENTION

It is the object of the invention to provide packaging for a lamp which protects the lamp against damage during its transportation and which can be produced in a simple manner, and to specify a corresponding method for packaging the lamp.

This object is achieved according to the invention by the features of patent claims 1 and 8, respectively. Particularly advantageous refinements of the invention are described in the dependent patent claims.

The packaging according to the invention has an inner part made of a dimensionally stable, flexible material which is provided with a recess for the lamp to be packaged. According to the invention, the recess is matched in an interlocking manner to the outer contour of the lamp to be packaged such that the interlocking design of the recess causes the lamp to be anchored in the recess. The lamp is thereby prevented from falling out of the recess and is protected by the inner part against any damage.

In order to improve the anchoring of the lamp in the recess, the contour of the recess is advantageously matched in an interlocking manner to more than 50 percent of the outer surface of the lamp to be packaged. As a result of this, the inner part also acts as a cushion for the lamp arranged in the recess. On the other hand, however, the lamp may also be easily removed from the recess by the customer since the inner part is made of a flexible material. The inner part preferably comprises a polyethylene terephthalate, polyvinyl chloride or polystyrene film. The thickness of this film is advantageously 150 μm to 300 μm, in order to ensure sufficient dimensional stability and strength. In accordance with the preferred exemplary embodiment of the invention, the packaging also has a cuboid collapsible box, in which the inner part is arranged diagonally. This optimizes the cushioning effect of the inner part.

The method according to the invention for packaging a lamp comprises the production of an inner part which is provided with a recess for a lamp. According to the invention, the lamp to be packaged is used to form the recess in the inner part. This provides a recess which is matched in an interlocking manner to the lamp contour and which ensures that the lamp is held securely in the inner part. Advantageously used as the inner part is a plastic film, preferably a polyethylene terephthalate film having a thickness in the region of 150 μm to 200 μm, which is heated up to produce the recess and is pressed against the lamp to be packaged by applying pressure. The heated-up, plastic film is thus matched exactly to the form of the lamp and is dimensionally stable once cooled such that the lamp is arranged in an interlocking manner in the recess. The heated-up plastic film is advantageously pressed against the lamp such that more than 50 percent of the outer surface of the lamp is surrounded by the film. Once the film has been cooled, more than 50 percent of the lamp surface is thus surrounded in an interlocking manner by the recess of the inner part. The inner part, with the lamp arranged in its recess, is inserted diagonally into a cuboid collapsible box in order to protect the lamp against damage and contamination.

### III. DESCRIPTION OF THE PREFERRED EXEMPLARY EMBODIMENT

The invention is explained in more detail below with reference to a preferred exemplary embodiment. In the drawings:

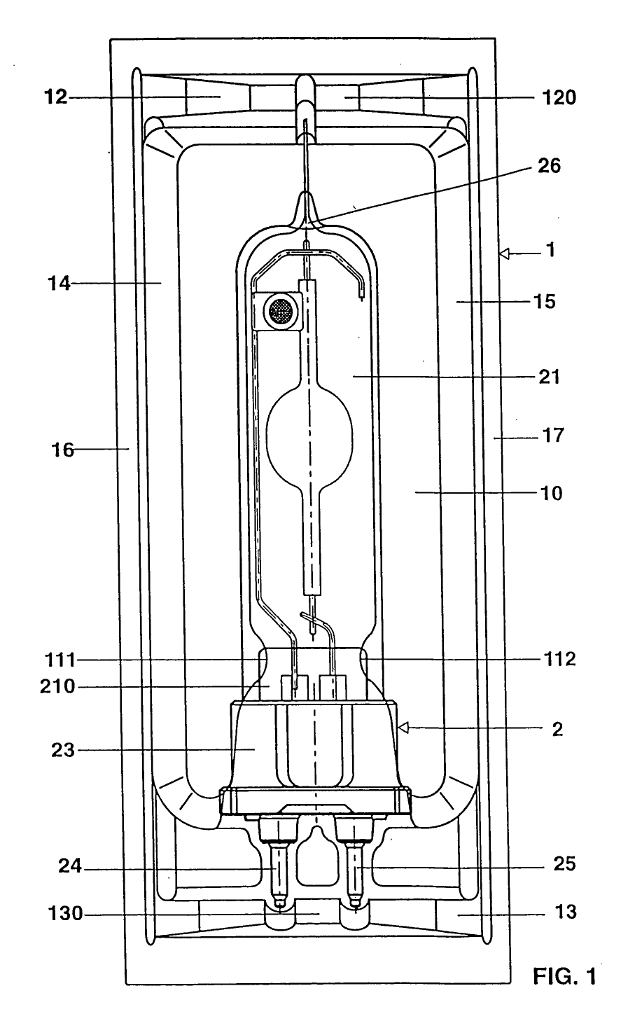

FIG. 1 shows a plan view of the inner part of the packaging according to the preferred exemplary embodiment of the invention with the lamp arranged therein,

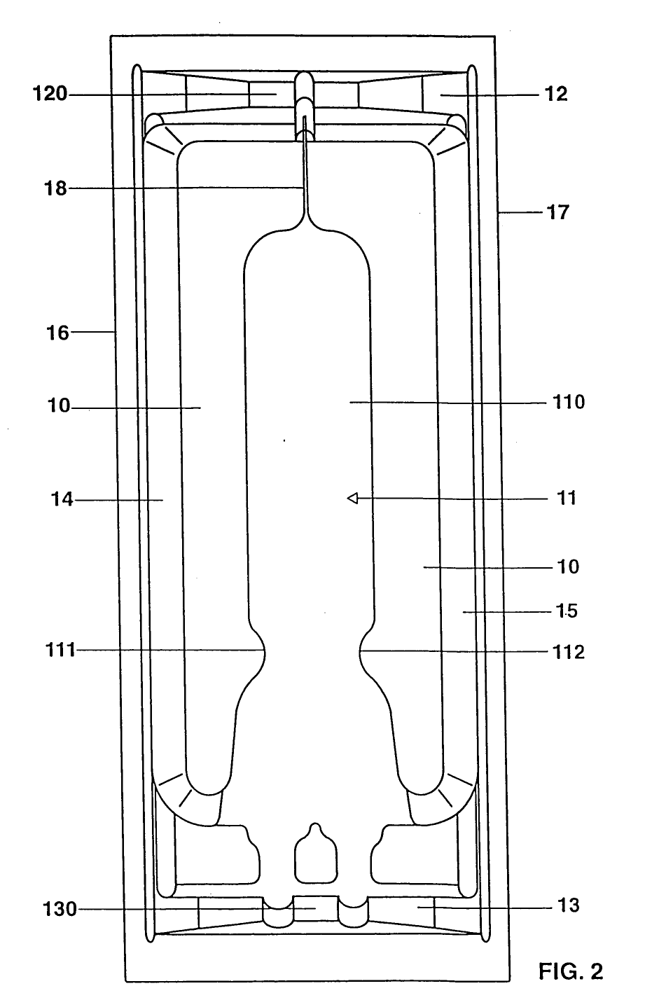

FIG. 2 shows a plan view of the inner part depicted in FIG. 1 without the lamp, and

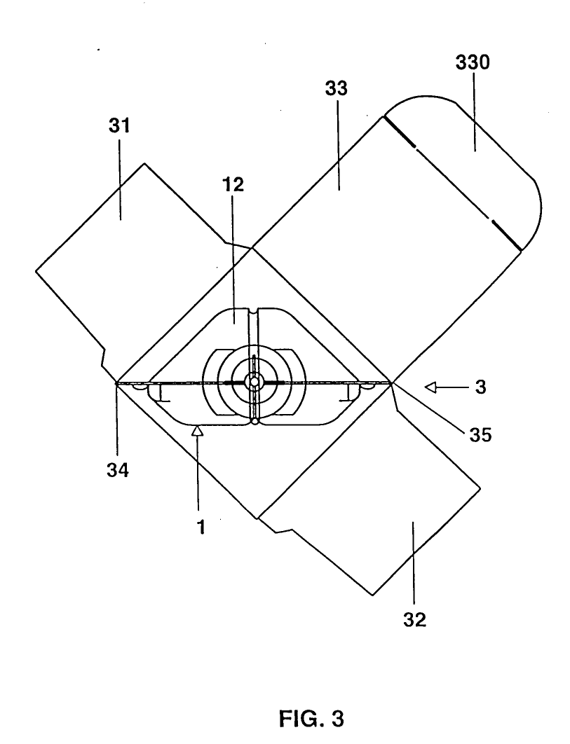

FIG. 3 shows a plan view of an open collapsible box having the inner part depicted in FIG. 1 and arranged therein.

FIG. 1 depicts an inner part 1 of packaging for a high-pressure discharge lamp 2. The inner part 1 comprises a transparent polyethylene terephthalate film. The thickness of this film is 150 μm to 200 μm. This inner part 1 has a recess 11 which is matched in an interlocking manner to the outer contour of the lamp 2. The depth of the recess 11 is matched to the corresponding dimensions of the lamp 2 transverse to its longitudinal extent such that the lamp 2 does not protrude beyond the recess 11. On one side of the inner part 1 the recess 11 has a withdrawal opening 110 for removing the lamp 2 from the recess 11. The withdrawal opening 110 is narrowed, i.e. the dimensions of the withdrawal opening 110 are smaller than the corresponding dimensions of the lamp 2. In the region of the recess 11, the inner part 1 surrounds approximately 60 percent of the surface area of the cylindrical outer bulb 21 of the high-pressure discharge lamp 2. in particular, the interlocking arrangement of the outer bulb 21 in the recess 11 extends over 60 percent of the circumference of the circular-cylindrical outer bulb 21. In the region of the outer bulb 21, the withdrawal opening 110 therefore has a smaller width, i.e. a smaller dimension transverse to the longitudinal extent of the lamp 2, than the outer diameter of the outer bulb 21. In analogy to this, the width of the withdrawal opening in the region of the lamp base 23 is also smaller than the width of the lamp base 23. In the region of the outer bulb seal 210, two diametrically arranged nipples 111, 112 are integrally formed on the edge of the withdrawal opening 110 and likewise have the effect of narrowing the withdrawal opening 110 or the recess 11. The contact pins 24, 25 of the lamp 2 are likewise arranged in an interlocking manner in the recess 11.

A web 12, 13, which extends transversely to the longitudinal extent of the lamp 2, is arranged at each end of the inner part 1. The two webs 12, 13 have the same height and are each provided with a flat bottom 120 and 130, respectively. In addition, the inner part 1 has two slopes 14, 15, which extend in the longitudinal direction, i.e. in the direction of the longitudinal extent of the lamp 2, and fall away from the top 10 of the inner part 1 in the direction of its longitudinal edges 16 and 17, respectively. These slopes 14, 15 and the webs 12, 13 contribute to the mechanical robustness, in particular to the dimensional stability, of the inner part 1. The exhaust tube 26 of the outer bulb 21 is arranged in a fold 18 in the inner part 1. The inner part 1 has a rectangular contour.

The packaging also has a cuboid collapsible box 3 made of cardboard, in which the inner part 1, with the lamp 2 arranged therein, is packaged. The inner part 1 is arranged diagonally in the collapsible box 3, as is illustrated schematically in FIG. 3. That is to say, the two longitudinal edges 16, 17 of the inner part 1 are arranged in two edges 34, 35 of the collapsible box 3, arranged diagonally opposite one another, and extend parallel to said edges 34, 35. The opening of the collapsible box 3 is closed by means of two dust flaps 31, 32 and a closure flap 33, which is provided with a fold-in tab 330.

For packaging purposes, the lamps 2 are inserted into the recess molds of a thermoforming machine. Subsequently, two or more, for example seven, recess molds are inserted into the thermoforming station at the same time transversely to the direction of travel. The heated-up polyethylene terephthalate film is pressed against the lamps and the recess molds by means of compressed air or by means of a vacuum. The lamps and the recess molds in this case act as dies for forming the inner parts 1. In particular the recesses 11 in the inner parts 1 are formed by means of the lamps 2, and, for example, the webs 12, 13, the slopes 14, 15 and the top 10 of the inner parts 1 are formed by means of the recess molds of the thermoforming device. Subsequently, the polyethylene terephthalate inner parts 1 produced in this manner are introduced individually and together with the lamp 2, which is in each case arranged therein, into the lead-in chain of the cartoning machine. The prefabricated collapsible boxes 3 are upended in the cartoning machine and filled with the inner parts 1.

The invention is not limited to the exemplary embodiment described in more detail above. Instead of the abovementioned preferred plastic materials, the plastic film may also comprise, for example, polyethylene or polypropylene.

1. A packaging for a lamp, the packaging having an inner part (1) made of a dimensionally stable, flexible material which is provided with a recess (11) for the lamp (2) to be packaged,
wherein the recess (11) has a contour which is matched in an interlocking manner to the outer contour of the lamp (2) to be packaged such that the interlocking design of the recess (11) causes the lamp (2) to be anchored in the recess (11).

2. The packaging as claimed in claim 1, wherein the contour of the recess (11) is matched in an interlocking manner to more than 50 percent of the outer surface of the lamp (2) to be packaged.

3. The packaging as claimed in claim 1, wherein the recess (11) has a withdrawal opening (110) for removing the lamp (2) from the inner part (1), the dimensions of the withdrawal opening (110) being narrowed.

4. The packaging as claimed in claim 1, wherein the inner part (1) is a polyethylene terephthalate, polyvinyl chloride or polystyrene film.

5. The packaging as claimed in claim 1, wherein the inner part (1) is a plastic film.

6. The packaging as claimed in claim 4, wherein the film has a thickness in the region of 150 μm to 300 μm.

7. The packaging as claimed in claim 1, wherein the packaging comprises a cuboid collapsible box (3), in which the inner part (1) is arranged.

8. The packaging as claimed in claim 7, wherein the inner part (1) is arranged diagonally in the collapsible box (3).

9. A method for packaging a lamp, an inner part (1) being formed by a recess (11) for the lamp (2), wherein the lamp (2) to be packaged is used to form the recess (11) in the inner part (1).

10. The method as claimed in claim 9, wherein the inner part (1) is a plastic film, which is heated up to produce the recess (11) and is pressed against the lamp (2) to be packaged by applying pressure.

11. The method as claimed in claim 9, wherein more than 50 percent of the outer surface of the lamp (2) is surrounded by the recess (11).

12. The method as claimed in claim 9, wherein the inner part (1), with the lamp (2) arranged in the recess (11), is inserted into a cuboid collapsible box (3) such that it is aligned diagonally.

13. The packaging as claimed in claim 2, wherein the recess (11) has a withdrawal opening (110) for removing the lamp (2) from the inner part (1), the dimensions of the withdrawal opening (110) being narrowed.

14. The packaging as claimed in claim 5, wherein the film has a thickness in the region of 150 μm to 300 μm.

15. The method as claimed in claim 10, wherein more than 50 percent of the outer surface of the lamp (2) is surrounded by the recess (11).

16. The method as claimed in claim 10, wherein the inner part (1), with the lamp (2) arranged in the recess (11), is inserted into a cuboid collapsible box (3) such that it is aligned diagonally.
